(19) United States
(12) Patent Application Publication
(10) Pub. No.: US 2002/0094357 A1
(43) Pub. Date: Jul. 18, 2002

(54) Hydrolysate assisted phytic acid reduction and feed modification method

(75) Inventors: Pedro Aloise, Vancouver (CA); David J. Saxby, West Vancouver (CA)

Correspondence Address: John Russell Uren, P. Eng., Suite 202, 1590 Bellevue Avenue, West Vancouver, BC, V7V 1A7, CA

(73) Assignee: Biozyme Sytems Inc.

(21) Appl. No.: 09/760,197

(22) Filed: Jan. 12, 2001

(51) Int. Cl. A23L 1/10

(52) U.S. Cl. 426/18

(57) ABSTRACT

A fish, krill or fish by-product hydrolysate is added to canola meal or like cereal. Phytase enzymes are added to the liquid material with the pH and temperature of the mixture being held at optimum for the phytase enzymes. The mixture is stirred for a predetermined time period to incubate the mixture under the desired pH and temperature conditions. Thereafter, the mixture is acid stabilised for storage and may further be dried or co-dried with other feed ingredients. The phytic acid in the canola meal is transformed and releases the previously bound phosphorous. The quantity of phytic acid in the canola meal is reduced significantly thereby reducing the antinutritional factors in the cereal. The benefits include a reduction of the phosphate necessary to be added as a supplement to the diet and an increase in protein absorption by the fish or animal. Further, less phytate bound phosphorous is added to the environment. Other enzymes and cereals having similar utility are contemplated.

### INTRODUCTION

This invention relates to the modification of feed components to improve the nutritional quality of the feed and to utilising an aqueous base media for such feed ingredient modification. More particularly, the invention relates to hydrolysate assisted phytic acid reduction in cereals and cereal byproducts so as to modify the feed and increase its nutritional value.

### BACKGROUND OF THE INVENTION

In certain cereals and cereal byproducts used in the feed industry for aquaculture and animal husbandry, which cereals would otherwise be valuable in increased quantities within feed products, the quantity of the cereals and cereal byproducts cannot be included at higher percentages because of the high content of antinutritional factors. For example, canola meal contains phytic acid which is a major antinutritional factor. Phytic acid complexes phosphate and makes it unavailable to the animal. The diet must then be supplemented with other sources of available phosphate. Likewise, the phytate bound phosphorous is deposited as a waste product in the environment which is undesirable. In addition to complexing phosphate, phytic acid also interferes with the absorption by the animal of proteins present in the diet. These proteins are otherwise valuable to the animal within the feed product.

A further antinutritional factor is the presence of non-starch polysaccharides (NPS) in the fiber fraction of cereals. These compounds are not absorbed by the fish or animal and therefore do not contribute to the overall energy of the feed product. They further create a viscous digesta that reduces the absorption of other valuable nutrients in the feed product.

Stone, Hardy and Spinelli in a publication entitled “Autolysis of Phytic Acid and Protein in Canola Meal, Wheat Bran and Fish Silage Blends,” J. Sci. Food Agric., 1984, 35, 513-519, disclose using a fish silage and a natural source of phytase, namely wheat bran, to release the bound phosphorous from phytic acid and thereby reduce the amount of phytic acid in the canola meal added to the fish silage. This was significant; however, the length of the process was very long (approximately thirty-five (35) days) and was therefore not commercially viable.

Adding phytases or fiber degrading enzymes to the finished feed pellet that contains canola meal or other grains is also known. When the pellet is ingested, the feed components comprising the canola meal plus the phytases, are released into the stomach of the animal where the desired enzymatic reaction occurs. The difficulty with this technique, however, is that the phytases working in the enzymatic process are working under pH and temperature conditions that are far from optimal. In fish, temperature conditions are relatively much lower than in other animals, so that the problem of obtaining optimal enzymatic activity is exacerbated. Further, it is difficult to measure the enzymatic additions. Estimates are necessary over weeks or months based on the growth rate of the fish or animal compared with the growth rates using untreated diets. While it would be possible to reproduce the enzymatic modification on the feed component such as canola meal outside the animal prior to the manufacture of the pellet and therefore measure the extent of the enzymatic transformation which converts the phytate bound phosphate into free phosphate, the otherwise dry canola meal must be rehydrated into a slurry for the enzymatic reaction to take place. After the enzymatic treatment, the canola meal slurry is again required to be dried in order to form the feed pellet. This process would be inefficient and overly expensive.

In our copending United States patent application entitled PROCESS FOR RECOVERING BONE AND OIL FROM ANIMAL BYPRODUCTS filed May 19, 2000 and carrying Ser. No. 09/574,368, the contents of which are herein disclosed by reference, there is disclosed a method of using proteolytic enzymes for transforming fish and byproducts into liquid hydrolysates. In our copending United States patent application entitled METHOD AND APPARATUS FOR HARVESTING, DIGESTION AND DEHYDRATING OF KRILL HYDROLYSATES AND CO-DRYING AND PROCESSING OF SUCH HYDROLYSATES filed Feb. 9, 1998 and carrying Ser. No. 09/020,695, the contents of which are herein disclosed by reference, there is disclosed a method of transforming Antarctic krill (euphausiid superba) into a liquid. Such liquid hydrolysates are valuable additions for aquaculture and other animal feeds since they have nutritional properties which favor nutrient uptake and facilitate absorption. The hydrolysates further contain in their dilute form approximately 80% water. This high water content can be used to assist further transformations of feed ingredients.

### SUMMARY OF THE INVENTION

According to one aspect of the invention, there is provided a method of adding a cereal feed ingredient to a liquid hydrolysate, adjusting the pH and temperature of the mixture of said cereal feed ingredient and said liquid hydrolysate in accordance with the optimal enzymatic activity using a predetermined enzyme, adding said predetermined enzyme to said mixture, maintaining said enzymatic activity within said mixture for a predetermined time period under said adjusted pH and temperature conditions to obtain a release of phosphorous from said cereal feed ingredient, stabilising said mixture to prevent bacteria formation and preserving said stabilised mixture as a feed ingredient.

According to a further aspect of the invention, there is provided a product produced by the aforementioned method.

### DESCRIPTION OF SPECIFIC EMBODIMENT

It is proposed to add a liquid hydrolysate to canola meal or other grains used in feed material to transform enzymatically the canola meal or other grains. The liquid hydrolysate could be derived from fish, krill or animal byproducts. Such other grains include but are not limited to sorghum, soybean meal, triticale, barley, peas, feather meal, oats, wheat, rye and the like.

After adding the liquid hydrolysate to the feed material, the pH and temperature of the mixture or slurry is carefully adjusted to match the proper profiles of the enzymes of interest so that the enzymatic transformation takes place under optimal conditions. The enzymes used would include phytases, proteases, amylases, xylanases, glucanases, hemicellulases and/or other fiber degrading enzymes. Such enzymes could be used individually or in combination.

The slurry is stirred for a period ranging from thirty (30) minutes to a maximum of six (6) hours. Thereafter, the slurry is acid stabilised for storage or dried directly or co-dried onto other feed ingredients.

For the specific case using the phytase enzyme, the canola meal was added to the hydrolysate in a quantity of 10-15% by weight. The pH was lowered to between 5.0-5.5 to match the optimum for phytase. The phytases were added at a rate of 500,000 to 1,000,000 FTU/ton of mixture which comprises 100-200 g of phytase/ton of hydrolysate-canola meal. The temperatures were kept between 50-55 deg. C. for 2-6 hours and stirred during this period. The mixture was thereafter acidified using formic acid to give a pH of below 4.0 for stabilization. Thereafter, the mixture was dried for storage.

### EXAMPLE

It was desired to produce an enzymatic reduction of phytic acid in canola meal using a liquid fish hydrolysate. The following were the specifics of the process.

Fish waste was ground and heated to 60-65 deg. C. The ground material was deboned to separate the bones from the remaining material. 100 g/ton of papaine was added to the meat portion and incubated with stirring for two (2) hours. 300 Kg of canola meal was added to the liquid fish hydrolysate which quantity was 1.7 tons. The pH was then adjusted with formic acid to between 5.0-5.5 which was the optimal pH for phytase. Phytase enzyme was then added at a rate of 100 g/ton of mix comprising the canola meal and the fish hydrolysate. A commercially available phytase enzyme was used, conveniently in this instance NATUPHOS (Trademark) 5000 powder obtained from BASF having 5000 FTU/g. This was equivalent to 500,000 FTU/ton of mix since one FTU is defined as the amount of phytase that will liberate one (1) micromole of inorganic phosphorous per minute from sodium phytate at 37 deg. C. and at a pH of 5.5. The mix was stirred for four (4) hours and held at 50 deg. C. Samples were taken before the addition of phytases (time zero) and at two (2) and four (4) hour intervals after the addition of the phytase for measuring the residual content of phytic acid in the canola meal and hydrolysate mix.

Assuming the amount of phytic acid in the mix before the addition of the phytases is defined as 100%, two (2) hours of incubation reduced that amount to 18.4%. After four (4) hours, it was further reduced to less than nine percent (9%) of the initial values in the mix.

Thereafter, the mixture after phytic acid reduction was acidified with formic acid to a pH below 4.0 in order to stabilise the mixture against bacterial contamination.

Many modifications may readily be envisioned by those skilled in the art to which the invention relates and the specific embodiments described should be taken as illustrative of the invention only and not as limiting its scope as defined in accordance with the accompanying claims.

I claim:

1. Method of adding a cereal feed ingredient to a liquid hydrolysate, adjusting the pH and temperature of the mixture of said cereal feed ingredient and said liquid hydrolysate in accordance with the optimal enzymatic activity using a predetermined enzyme, adding said predetermined enzyme to said mixture, maintaining said enzymatic activity within said mixture for a predetermined time period under said adjusted pH and temperature conditions to obtain a release of phosphorous from said cereal feed ingredient, stabilising said mixture to prevent bacteria formation and preserving said stabilised mixture as a feed ingredient.

2. Method as in claim 1 wherein said mixture is acid stabilised.

3. Method as in claim 1 wherein said mixture is stabilised by drying.

4. Method as in claim 1 wherein said stabilised mixture is dried.

5. Method as in claim 3 wherein said mixture is dried by codrying onto a further feed ingredient.

6. Method as in claim 4 wherein said mixture is dried by codrying onto a further feed ingredient.

7. Method as in claim 1 wherein said cereal feed ingredient is canola meal, sorghum, soybean meal, triticale, barley, peas, oats, wheat and/or rye.

8. Method as in claim 1 wherein said enzyme is a commercially available enzyme.

9. Method as in claim 8 wherein said commercially available enzyme is a phytase.

10. Method as in claim 1 wherein said enzyme is a phytase, said pH is adjusted between 5-5.5 and said temperature is adjusted between 50-55 deg. C.

11. Method as in claim 10 wherein said predetermined period is between thirty (30) minutes and six (6) hours.

12. Method as in claim 1 wherein said enzyme is one or a combination of phytases, hemicellulases, cellulases, xylanases, glucanases, amylases, proteases and/or other fiber degrading enzymes.

13. Method according to claim 1 wherein said cereal feed ingredient is one or a combination of canola meal, triticale, rye, sorghum, barley, oats or wheat, said liquid hydrolysate is a fish or krill based hydrolysate, said predetermined enzyme is a phytase, said pH is adjusted to between 5 and 5.5, said temperature is adjusted between 50 and 55 deg. C. and said predetermined time period for maintaining said enzymatic activity is between thirty (30) minutes and six (6) hours.

14. Method according to claim 1 wherein said cereal feed ingredient is one or a combination of canola meal, rye, barley, wheat, sorghum, triticale, oats, or feather meal, said liquid hydrolysate is a fish or krill based hydrolysate and said enzyme is one of a combination of hemicellulases, cellulases, xylanases, glucanases, amylases, proteases or a further fiber degrading enzyme.

15. Product produced by any one of the methods of claims 1-14.
